(19) United States
(12) Patent Application Publication
(10) Pub. No.: US 2002/0037077 A1
(43) Pub. Date: Mar. 28, 2002

(54) TELEPHONE TERMINAL BASE

(76) Inventors: CLIFFORD D. READ, STITTSVILLE (CA); ROBERT C. TEMPLIN, STITTSVILLE (CA)

Correspondence Address: ANGELA C DE WILTON, NORTEL NETWORKS CORPORATION, INTELLECTUAL PROPERTY LAW GROUP, PO BOX 3511 STATION C, OTTAWA, K1Y4H7, CA

(21) Appl. No.: 09/343,535

(22) Filed: Jun. 30, 1999

(51) Int. Cl. H04M 1/00; H04M 9/00

(52) U.S. Cl. 379/419

(57) ABSTRACT

A telephone terminal base, particularly suited to call centre use in combination with a headset, which includes a body having keypad portion and an elongate display portion which extends laterally of the keypad portion to form a body with an L shape sidewall, contoured to fit against the sides of a computer keyboard. Preferably the telephone base has a substantially symmetrical T shaped form, a laterally elongate display portion forming the horizontal part of a T and the relatively narrow keypad portion forming the vertical part of the T. In symmetric T shaped form, the phone may be placed either side of a conventional computer keyboard, adjacent the keyboard with the display portion extending along the top edge of the keyboard, for right or left handed use as appropriate. Alternatively, the body may have L shaped form for left or right use. The terminal takes up relatively little desktop area, and the keypad is conveniently positioned for use concurrently with computer keyboard and a mouse, with the display conveniently angled for use without excessive glare.

### FIELD OF THE INVENTION

This invention relates to a telephone terminal base, with particular application for a display terminal base for use with a headset for call centre applications.

### BACKGROUND OF THE INVENTION

Call centre operators typically work in a limited workspace provided by workstation in a cubicle having limited desktop area, accommodating a conventional computer terminal with a display and keyboard, and a conventional telephone with a headset. Operators may also need additional desktop space to have hardcopy reference materials, e.g. reference binders readily to hand. To reduce overhead costs, such call centres typically accommodate a large number of operator workspaces in a very limited area, and rely on standard, relatively low cost, computer and telephone equipment providing the required functionality. Since operators are constantly operating the phone and concurrently accessing information using the computer and reference materials, an ergonomic arrangement of equipment is desirable. Thus, advantageously, the computer display screen, keyboard, with mouse, and telephone need to be arranged so as to be easily and comfortably operable over extended periods.

Less sophisticated operations may find a conventional phone and hard copy reference materials is sufficient. Other operations may rely heavily on the computer system to access or input information on line. With the convergence of telephony and data network communications and IP telephony, a personal computer connected to a conventional switched network may be used for telephony functions, or a computer or IP telephone terminal connected to an IP network may alternative be used for telephone functions.

Studies have shown that while the use of the computer screen and keyboard may be useful for input and display of particular information, continually scrolling through graphical information on a computer screen, using a mouse and cursor to point and click can be tiring. Experienced operators often prefer to use keyboard inputs to rapidly input and navigate through data. It is reported that frequent repetition of standard telephony functions are usually most efficiently accomplished with a conventional telephone terminal.

Furthermore, for low cost call centre operation, it is preferred that the equipment provided is standard, relatively basic and inexpensive, avoiding complex computer based operations in favour of simple telephone based commands. Such a system is relatively easy to operate by an untrained operator familiar with operation of a conventional phone system, with minimal specialized training. Training can typically be accomplished in two days for operators who are primarily using telephone based commands, e.g. with manual look up of information. Avoiding the extensive training required for more sophisticated computer applications may be beneficial for operations where there is high staff turnover.

Thus in a call centre environment, a conventional telephone terminal with a small display screen is often preferred for tasks which are primarily conventional telephony tasks, while the computer display and keyboard may be preferred for more sophisticated or extensive information retrieval, display and management.

On the other hand, a problem encountered by operators using a both desktop computer and a conventional desktop phone is finding an ergonomic layout of the phone, computer keyboard and mouse on the desk which is convenient and comfortable for extended use, particularly in a call centre environment. While various compact telephones are known, reducing the size of the phone often compromises the area available for the key pad, or the display, which result in reports of user dissatisfaction during extended use since the layout of the keypad is perceived to be too cramped.

### SUMMARY OF THE INVENTION

Thus, the present invention seeks to provide a telephone terminal base which overcomes or avoids the above mentioned problems.

One aspect of the present invention provides a telephone terminal base comprising a body having a display portion and a key pad portion, the body having an inclined top face carrying the keypad and display, and the display portion extending laterally of the keypad portion on at least one side to define a sidewall having an L shape.

Thus, where the display portion extends laterally of the keypad portion on one side the telephone base takes the form of an L-shaped body.

Preferably the display portion extends laterally of the keypad portion on opposite sides to provide a T shaped body. Thus a phone base is provided which has an inclined faceplate to define wedge-shaped, L shaped or T shaped body.

The shape of the phone base allows it to fit closely adjacent a conventional rectangular computer keyboard, and the inclined faceplate of the terminal conforms to the slope of an conventional keyboard.

Beneficially the T shaped telephone terminal base has a symmetrical configuration, and may be placed either side of a conventional computer keyboard for convenient use by either left or right handed users. This configuration thus provides an ambidextrous phone.

Alternatively when the telephone terminal base has L shaped form, it may take a right or left handed form for placement at a corresponding side of the keyboard.

Advantageously the telephone terminal base is shaped to have a profile corresponding to the computer key pad, the keypad being incline similarly to the computer keypad so that the user may efficiently and comfortably move a hand between the computer keyboard to the telephone keypad.

Typically, the telephone base is used with a headset, rather than a conventional handset. Jacks for headsets an operator and supervisor are conveniently placed, with a recess under the body for routing cables. The telephone terminal base thus takes up reduced desktop space, while providing a standard size telephone keypad and function keys and a display screen.

Conveniently, when the phone base comprises a display portion and keypad portion in the form of a T shape, the display portion forming the horizontal part of the T and the keypad forming the vertical part of the T. By selecting dimensions of the T shaped body of the terminal base to fit around an edge or corner of the computer keyboard, a convenient and compact display phone is provided which minimize the amount of the desktop area required. Conveniently, the positioning of the keypad adjacent the keyboard with the display extending from the telephone base along the top of the keyboard, is ergonomically arranged for concurrent operation of the telephone terminal and the computer terminal and keypad. The telephone base is positioned so that the keypad portion of telephone terminal takes up minimal space laterally, and allows a mouse pad to be conveniently placed adjacent the keypad portion of the terminal base and close enough for convenient use.

Thus, for users such as call centre operators, a very compact display phone is provided which conveniently fits on the desktop, around a conventional computer keyboard and takes up little desk area. Thus the telephone base is particularly convenient for operators who must concurrently use the telephone and a conventional computer terminal.

Optionally, the terminal body accommodates a computer telephony interface module, e.g a connection to a separate CTI interface card module, or where space permits, provides a socket at the back for receiving a CTI interface card directly, to support more fully integrated computer and telephony functions.

According to another aspect of the present invention another form of the phone provides a telephone base with a display portion and an associated keypad portion movable relative to the display portion between a first position for left handed use and second position for right handed use.

Other home and office users may find the T-phone or L-phone terminal base particularly convenient where space is limited at a computer workstation, or for concurrent frequent use of a both phone and computer keyboard and mouse.

### BRIEF DESCRIPTION OF THE DRAWINGS

The invention will now be described in greater detail with reference to the attached drawings wherein:

FIG. 1 shows a schematic diagram of an oblique view of the telephone terminal base according to a first embodiment;

FIG. 2 shows a schematic diagram of a top view of the terminal base of FIG. 1 along arrow II;

FIG. 3 shows a schematic diagram of a side view of the terminal base of FIG. 1 along arrow III; and FIG. 3A shows the same view of a modified version of the first embodiment;

FIG. 4 shows a schematic diagram of the telephone terminal base of FIG. 1, for use in association with a conventional computer keyboard;

FIG. 5 shows a schematic diagram of a telephone terminal base according to a second embodiment;

FIG. 6 shows a schematic diagram of a telephone terminal base according to a third embodiment;

FIG. 7 shows a schematic diagram of a telephone terminal base according to a fourth embodiment.

### DETAILED DESCRIPTION OF THE INVENTION

A telephone terminal base according to a first embodiment of the invention is shown in FIG. 1, and comprises a body 10 having a display portion 20 and a keypad portion 30. The display portion 20 includes a graphical display screen 22 and optional function keys 24, and the keypad portion 30, accommodates a conventional numeric telephone keypad 32 and optional function keys 34. The display portion 20 is laterally elongate and extends at right angles laterally from the narrower, approximately rectangular keypad portion 30 of the body on each side, to form a body with an L shaped side sidewall 36 on each side, thereby forming a body which from a top view has an overall symmetrically T shaped body (FIG. 2).

As shown in FIG. 3, which is a side view along arrow III of FIG. 1, the top face of the body 40, carrying the keypad 32 and function keys 34, and the display screen 22 and function keys 24, is inclined to form a wedge shaped body. Conveniently, the bottom 42 of the body is formed with a recess 44 under the body for routing cables.

Jacks 50 for operator and supervisor headsets are also provided in a convenient part of the body, e.g. in this embodiment jacks 50 are provided at the side 52 of the display portion of the body.

Optionally, the terminal body accommodates a standard CTI interface card module to support more fully integrated computer and telephony functions. For example in a modified version shown in FIG. 3A, the back of the body 46, provides a socket 48 for receiving a CTI interface card (shown in dotted outline 49) if space on the desktop allows. Alternatively, in other embodiments, a connection to a separate CTI interface card module is provided (not shown).

FIG. 4 shows how the T shaped telephone base 10 of FIG. 1 is positioned for operation, with a conventional computer keyboard 100 for use by a right handed operator. The phone base 10 is placed adjacent the keyboard 100, with the keypad portion 30 aligned against the side 102 of the keyboard and the display portion 20 extending along the top edge 104 of the keyboard, wrapping around the keyboard. Conveniently, the size, shape and profile of the telephone base 10 are selected to conform to the shape and profile of a standard computer keyboard 100. Thus the phone base 10 fits snugly against the computer keyboard, taking up little additional desk space. The operator may move easily between using the keyboard and keypad on the telephone. A conventional headset 130 is shown by way of example, plugged into one of the jacks 50 on the side of the terminal body 10.

As shown in FIG. 4, the relatively narrow keypad portion 30 of the body allows for a conventional mouse 120 and mouse pad 122 to be placed adjacent the keypad portion 30 within convenient reach. The elongate display portion 20 lies along the top of the keyboard to allow a relative wide display screen, and extends outwards from the keyboard 100 a sufficiently small distance to fit conveniently between the keyboard 100 and computer display and/or processor module 200 as they would typically be arranged (shown in dotted outline in FIG. 4).

The telephone terminal base 10 thus takes up reduced desktop space, while providing a standard size telephone keypad and function keys arranged with standard inter key spacing, and a conveniently sized display screen. The positioning of the keypad adjacent the keyboard with the display extending from the telephone base along the top of the keyboard, is ergonomically arranged for concurrent operation of the telephone terminal and the computer terminal and keypad. The keypad portion of telephone terminal takes up minimal space laterally, and allows a mouse pad to be conveniently placed adjacent the keypad portion of the terminal base and close enough for convenient use.

In call centre environment, some tasks are most easily achieved by keypad operations and other tasks are more conveniently achieved by navigating with cursor and mouse through graphically displayed information. The resulting combination of conventional keyboard and associated telephone keypad and function keys provides a very flexible combination of input means for ease of operation.

Thus, for users such as call centre operators, a very compact display phone is provided which conveniently fits on the desktop, around a conventional computer keyboard and takes up little desk area. Thus the telephone base is particularly convenient for operators who must concurrently use the telephone and a conventional computer terminal.

The symmetrical T shaped form of the phone shown in FIGS. 1 to 4 is preferred, in that it can be used ambidextrously, and placed either side of a keyboard for right or left handed use. Advantageously the telephone terminal base is shaped to have a profile corresponding to a standard computer key pad, the keypad being inclined similarly to the computer keypad so that the user may efficiently and comfortably move a hand between the computer keyboard to the telephone keypad. Furthermore, it is found that when the inclination of the top face is that of a standard computer keyboard, the display screen is conveniently angle for use without troublesome glare. Thus although a movable tilt display screen could be used in alternative embodiments, the fixed screen orientation as shown was satisfactory, and reduces manufacturing costs relative to a movable tilt display portion.

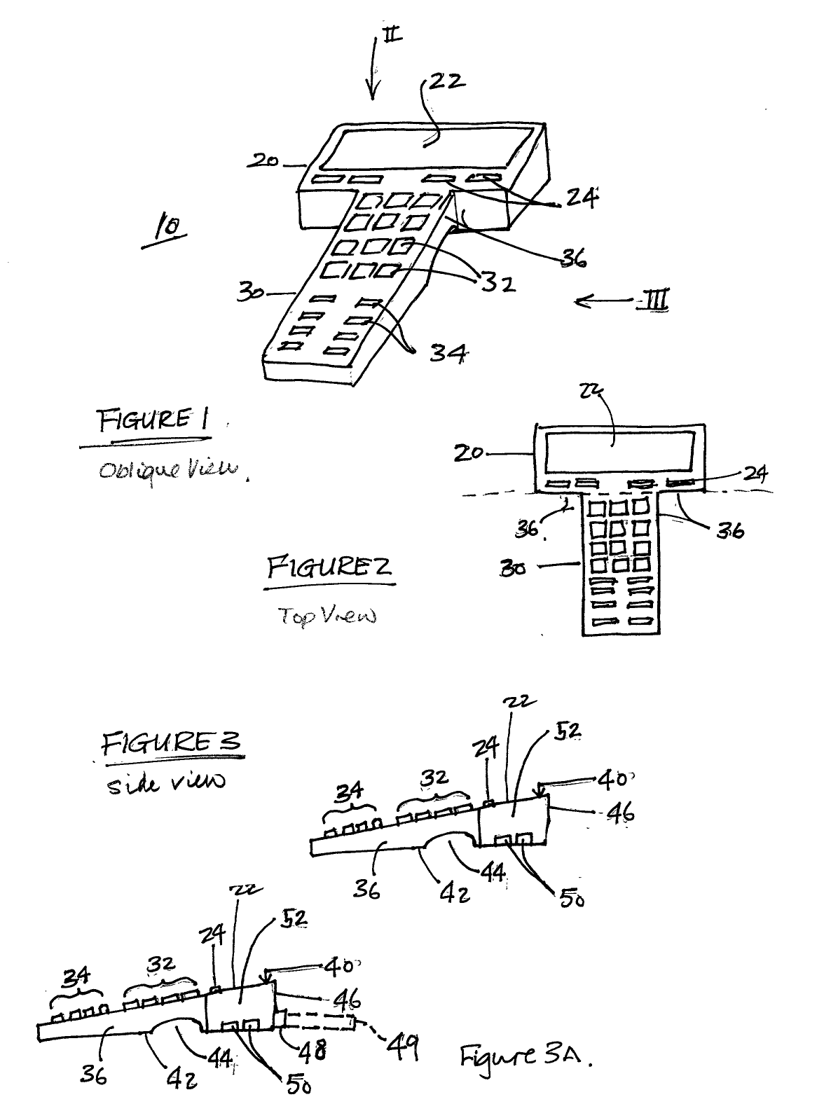

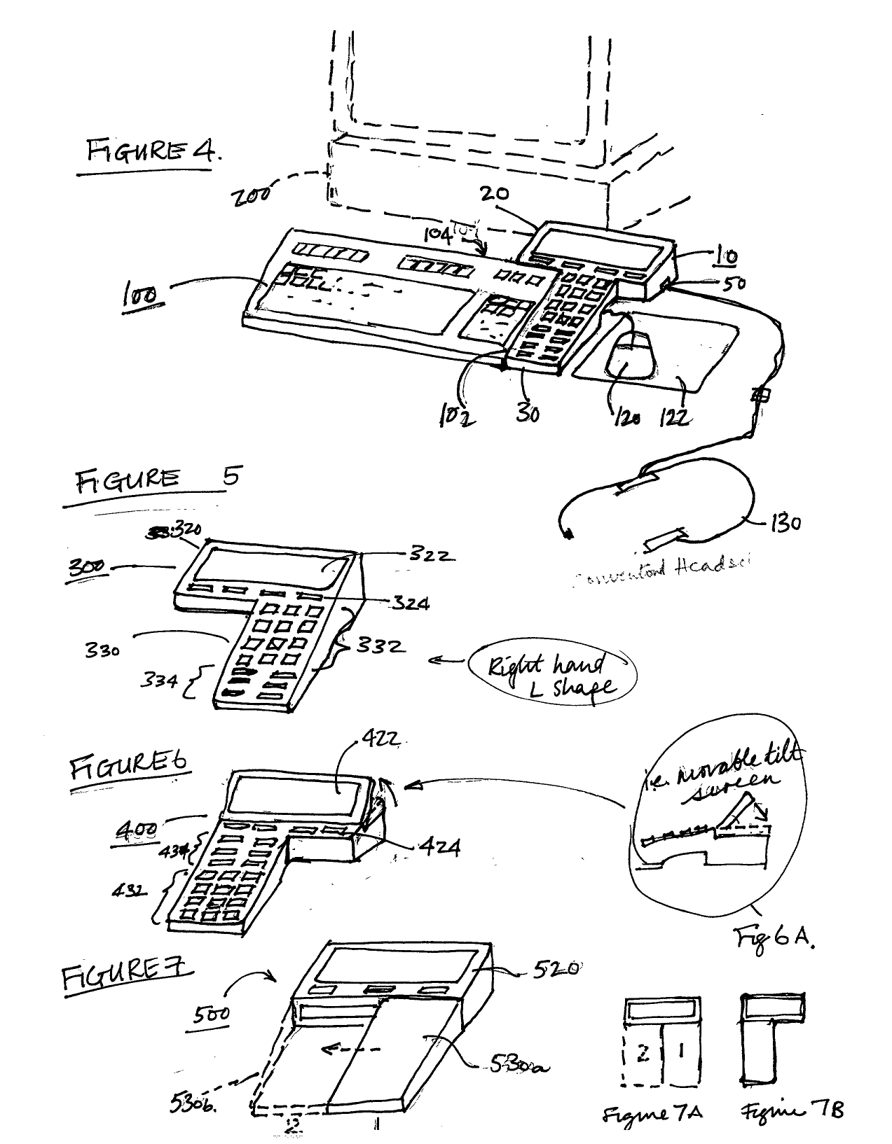

There are manufacturing and marketing advantages in making an ambidextrous version of the telephone base which conforms to the profile of standard computer keyboards. However, alternatively the telephone terminal base according to a second embodiment has L shaped form, and may take a right handed form 300 as shown in FIG. 5 or a left handed form 400, as shown in FIG. 6, the latter being shown with a movable tilt screen 422. (For ease of comparison, in respective FIGS. 5 to 7, similar features relative to those of FIGS. 1 to 4 are shown with like reference numerals incremented by multiples of 100.)

The relative positioning of the standard telephone keypad and optional function keys may be arranged appropriately depending on whether the call centre is primarily an incoming call centre or outgoing call centre, to ensure the most frequently used keys are in convenient reach of the operator.

Thus for example the keypad configuration as shown in FIGS. 1 to 4, and e.g in FIG. 5 would typically be preferred for incoming call centre use, with the telephone keypad positioned above the optional function keys which would be positioned to be closest to the operator. As shown in FIG. 5, with the telephone keypad 432 positioned to be closer to the operator, would be appropriate for outgoing call centre use where the telephone keypad operations would be more frequently performed.

Advantageously, the terminal body provides for connection to a computer telephony interface (CTI) card module, to support more fully integrated computer and telephony functions so that the terminal base functions as a computer telephony interface module.

In a telephone base according to another embodiment, FIG. 7, the telephone base has a display portion and an associated keypad portion movable relative to the display portion between a first position for right handed use and second position for left handed use (FIGS. 7A and 7B). Nevertheless, from a manufacturing and marketing perspective the fixed T shape provides a lower cost option for ambidextrous use, and minimizing movable parts or detachable connections which reduce reliability.

While the above described telephone bases have particular applications for call centre operations, other home and office users may find the T shaped or L shaped terminal base particularly convenient where space is limited at a computer workstation, or for concurrent frequent use of both phone and computer keyboard and mouse.

The terminal base in the T shaped form has particular application for call centre applications in association with conventional rectangular computer keyboards, in workstations having limited area. The basic T shaped ambidextrous version provides advantage in terms of manufacturing cost and marketing over separate right and left handed L shaped versions. Alternative embodiments are envisaged which are generally T shaped or L shaped, with various keypad and function key configurations, and profiled to fit adjacent standard rectangular keyboards and other conventional computer keyboards.

Other alternative embodiments are envisaged with other variations of known telephone base features, for example an adjustable tilt display screen, and alternative screen, keypad and function key layouts.

Although specific embodiments of the invention have been described in detail, it will be apparent to one skilled in the art that variations and modifications to the embodiments may be made within the scope of the following claims.

What is claimed is:

1. A telephone terminal base comprising a body having a display portion and a relatively narrow key pad portion, the body having an inclined top face, and the display portion extending laterally of the keypad portion on at least one side to define a sidewall having an L shape.

2. A telephone terminal base according to claim 1 wherein the display portion extends laterally of the keypad portion on one side the telephone base to provide an L-shaped body.

3. A telephone terminal base according to claim 1 wherein the display portion extends laterally of the keypad portion on opposite sides to provide a T shaped body.

4. A telephone terminal base according to claim 3 wherein the T shaped body has a symmetrical configuration.

5. A telephone terminal base according to claim 3 having means for accommodating a computer-telephony interface module.

6. A telephone terminal base according to claim 5 wherein the computer-telephony module comprises a CTI interface card.

7. A telephone terminal base according to claim 1 wherein a top face of the body is inclined to define wedge-shaped shaped body.

8. A telephone terminal base according to claim 1 wherein the body is formed with a recess for routing cables under the body.

9. A telephone terminal base according to claim 1 having connection means for a headset.

10. A telephone terminal base for use adjacent a computer keyboard, comprising a body having a display portion carrying a display screen and function keys, and a key pad portion carrying a telephone keypad and function keys,
the keypad portion being relatively narrow, and the display portion extending laterally of the keypad portion on opposite sides to define L shaped sidewalls, thereby providing a generally T shaped body,
whereby in use, the T shaped body of the telephone terminal base aligns against a side of a computer keyboard with the relatively narrow keypad portion adjacent a side of the keyboard and the display portion extending along a top edge of the keyboard.

11. A telephone base according to claim 10 wherein the profile of the T shaped body is selected to conform to that of the computer keyboard.

12. A telephone base according to claim 11 wherein a top face of the telephone based in inclined to correspond to the inclination of a top face of the computer keyboard.

13. A telephone base according to claim 9 having means for accommodating a computer telephony module.

14. A telephone base according to claim 13 wherein the computer telephony module comprises a CTI interface card.

15. An assembly of a computer keyboard and a telephone base module, comprising
a computer keyboard having a substantially rectangular body and a top face carrying a conventional key layout,
and a telephone base module comprising:
a body having a display portion and a relatively narrow key pad portion, the body having an inclined top face, and the display portion extending laterally of the keypad portion on at least one side to define a sidewall having an L shape,
wherein the L shaped sidewall body fits against the computer keyboard with the relatively narrow keypad portion adjacent a side of the keyboard and the display portion extending along a top edge of the keyboard, the inclination of the top face of the terminal base carrying the keypad and display conforming to the inclination of the top face of the computer keyboard.
